(19) United States
(12) Patent Application Publication
(10) Pub. No.: US 2019/0208697 A1
(43) Pub. Date: Jul. 11, 2019

(54) SOIL OPENER WITH COMPOUND CARBIDE PROTECTION

(71) Applicant: Morris Industries Ltd., Saskatoon (CA)

(72) Inventors: Thomas Janzen, Yorkton (CA); Clint W. Sheppard, Yorkton (CA)

(73) Assignee: Morris Industries Ltd., Saskatoon (CA)

(21) Appl. No.: 16/238,287

(22) Filed: Jan. 2, 2019

Related U.S. Application Data
(60) Provisional application No. 62/614,156, filed on Jan. 5, 2018.

(51) Int. Cl. A01C 5/06; A01C 7/06

(52) U.S. Cl. CPC A01C 5/062; A01C 7/06

(57) ABSTRACT

An agricultural tillage tool is configured to be advanced along a field in a forward direction. The tool broadly includes a base tool structure and a pre-brazed wear tablet. The base tool structure is configured to engage the ground while being advanced. The wear tablet includes a metallic wear plate and a steel backing plate, with the plates being brazed to one another. The metallic wear plate includes a wear material and the backing plate includes a backing plate material, with the wear material having a hardness greater than the backing plate material. The backing plate is laser welded to the base tool structure so as to fix the pre-brazed wear tablet to the base tool structure, with the metallic wear element being located ahead of the backing plate relative to the forward direction.

### RELATED APPLICATION

This application claims the benefit of U.S. Provisional Application Ser. No. 62/614,156, filed Jan. 5, 2018, entitled SOIL OPENER WITH COMPOUND CARBIDE PROTECTION, which is hereby incorporated in its entirety by reference herein.

### BACKGROUND

### 1. Field

The present invention relates generally to agricultural implements. More specifically, embodiments of the present invention concern tillage tools that are reinforced by a wear tablet.

### 2. Discussion of Prior Art

Agricultural tillage tools are prone to significant wear from continuous and repeated ground engagement, and it is well known for ground-engaging tools to have wear-resistant features. In particular regard to soil openers, such tools are designed to form a furrow in the ground as the opener is advanced. The opener includes a ground-engaging tool structure with various surfaces that engage the ground to create the furrow. Conventional openers are also often designed to deposit seed and/or fertilizer into the open furrow.

It is known to those of skill in the art that the ground-engaging tool structure of the opener is prone to wear during normal use. For instance, although conventional openers include ground-engaging tools with hardened wear plates and reinforced surfaces, conventional openers commonly experience undesirable amounts of wear. As a result of normal tool wear, the tool structure loses its edge and does not penetrate the ground to the same degree. Tool wear changes the tool shape, which causes the furrow to have a different shape than originally intended. The changed tool shape also results in crop buildup on the tool. Tool wear also causes a lack of tool penetration that can affect furrow location (such as furrow depth). As a result, seed and fertilizer placement relative to the ground surface can be adversely affected.

### SUMMARY

The following brief summary is provided to indicate the nature of the subject matter disclosed herein. While certain aspects of the present invention are described below, the summary is not intended to limit the scope of the present invention.

Embodiments of the present invention provide an agricultural tillage tool that does not suffer from the problems and limitations of the prior art tillage tools set forth above.

A first aspect of the present invention concerns an agricultural tillage tool configured to be advanced along a field in a forward direction. The tool broadly includes a base tool structure and a pre-brazed wear tablet. The base tool structure is configured to engage the ground while being advanced. The wear tablet includes a metallic wear plate and a steel backing plate, with the plates being brazed to one another. The metallic wear plate includes a wear material and the backing plate includes a backing plate material, with the wear material having a hardness greater than the backing plate material. The backing plate is laser welded to the base tool structure so as to fix the pre-brazed wear tablet to the base tool structure, with the metallic wear element being located ahead of the backing plate relative to the forward direction.

A second aspect of the present invention concerns a method of reinforcing an agricultural tillage tool. The tool includes a base tool structure configured to engage the ground while being advanced in a forward direction. The method broadly includes the steps of fixing a metallic wear plate to a steel backing plate to provide a metallic wear tablet, with the metallic wear tablet presenting a tablet wear surface; and, after the fixing step, laser welding the backing plate to the base tool structure so that the tablet wear surface is exposed in the forward direction.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a top plan view of an agricultural implement with multiple openers constructed in accordance with a preferred embodiment of the present invention;

FIG. 2 is a fragmentary side elevation of the agricultural implement shown in FIG. 1, showing a mounting bracket, actuator, dispensing assembly, suspension, and gauge wheel of the openers, with the openers in an operating position where the openers engage the ground;

FIG. 3 is a fragmentary front perspective of the agricultural implement shown in FIGS. 1 and 2, showing one of the openers in a transport position, and showing a shank, shovel, boot, guide member, boot guard, shank wear tablet, and shovel wear tablets of the dispensing assembly;

FIG. 4 is a fragmentary rear perspective of the agricultural implement similar to FIG. 3, but taken from the opposite side, showing a linkage, shank support arm, suspension arm, and a trailing arm of the suspension;

FIG. 5 is a perspective of the dispensing assembly shown in FIGS. 3 and 4, showing the boot exploded from the shank;

FIG. 6 is a fragmentary perspective of the dispensing assembly shown in FIGS. 1-5, showing the shank wear tablet and boot guard exploded from the shank;

FIG. 7 is a fragmentary perspective of the dispensing assembly similar to FIG. 6, but taken from the opposite side;

FIG. 8 is a fragmentary perspective of the dispensing assembly similar to FIG. 6, but showing the shovel and guide member exploded from the shank, with the shank wear tablet and boot guard fixed to the shank;

FIG. 9 is a fragmentary perspective of the dispensing assembly similar to FIG. 8, but taken from the opposite side;

FIG. 10 is a fragmentary side elevation of the dispensing assembly shown in FIGS. 3-9, showing the shank plate and wear beads applied to the leading edge and sides of the shank plate by laser metal deposition, and further showing the shank wear tablet configured to be laser welded to the shank plate, with the shank wear tablet being pre-brazed and including a backing plate and a wear plate;

FIG. 11 is a fragmentary front elevation of the dispensing assembly shown in FIGS. 3-10, showing the shank plate and wear beads applied to the leading edge and sides of the shank plate by laser metal deposition;

FIG. 12A is a fragmentary front elevation of the shovel and shovel wear tablets shown in FIGS. 3-11, showing notches in the shovel plate configured to receive the shovel wear tablets, with the shovel wear tablets including a backing plate and wear plates;

FIG. 12B is a fragmentary front elevation of the shovel and shovel wear tablets similar to FIG. 12A, but showing the shovel wear tablets laser welded to the shovel plate;

FIG. 12C is a fragmentary front elevation of the shovel and shovel wear tablets similar to FIG. 12B, but showing wear beads applied to the upper surface of the shovel by laser metal deposition;

FIG. 13 is a fragmentary perspective of the guide member shown in FIGS. 3-9, showing a guide plate prior to application of wear beads thereto;

FIG. 14 is a perspective of the guide member similar to FIG. 13, but taken from the opposite side and showing wear beads applied to the guide plate;

FIG. 15 is a fragmentary perspective of the boot guard shown in FIGS. 3-9, showing a curved plate prior to application of wear beads thereto; and

FIG. 16 is a perspective of the boot guard similar to FIG. 15, but taken from the opposite side and showing wear beads applied to the curved plate.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

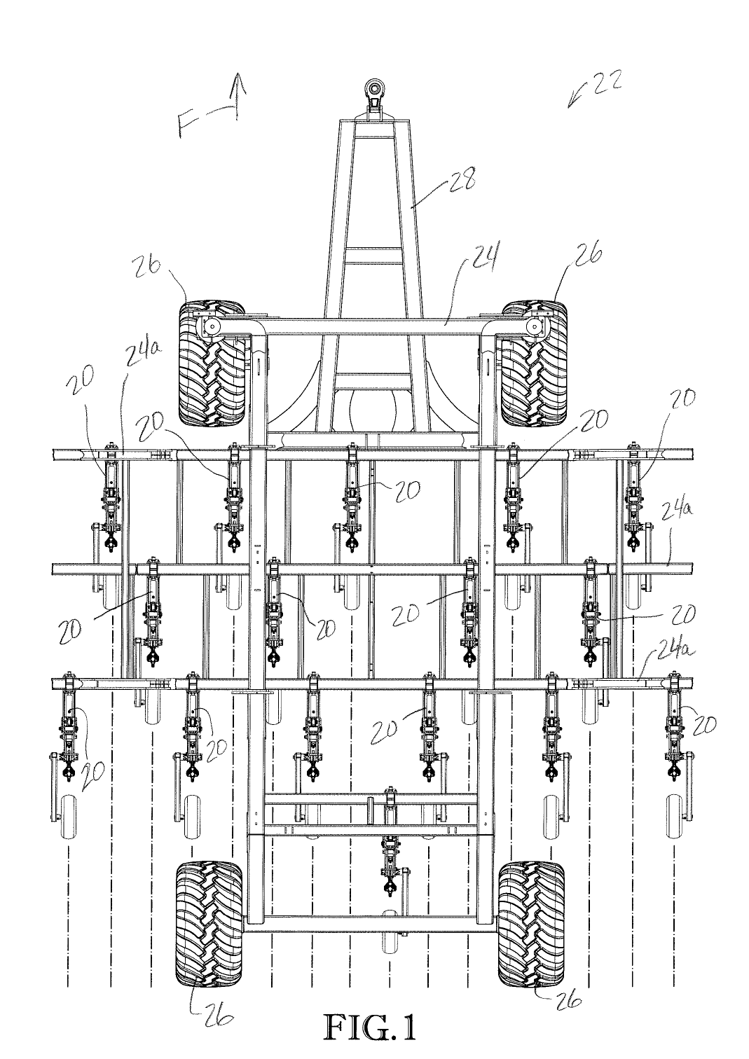

Referring initially to FIGS. 1-4, agricultural openers 20 are configured to be advanced in a forward direction F along the ground G. The openers 20 are preferably advanced by being towed behind an agricultural vehicle (not shown). In the usual manner, the openers 20 are operable to open a furrow (not shown) and deposit seed (not shown) and/or fertilizer (not shown) within the furrow.

Multiple openers 20 are preferably provided as part of an implement 22 (see FIG. 1). The implement 22 preferably includes a frame 24 with toolbars 24a, wheels 26 rotatably mounted on the frame, and a hitch 28. The implement 22 also includes a hydraulic system (not shown) to shift the disc openers 20 vertically. The hydraulic system preferably includes, among other things, hydraulic lines (not shown) that deliver hydraulic fluid to the openers.

Each opener 20 of the present invention is configured to dispense seed and/or fertilizer in the furrow while being advanced. The opener 20 preferably includes a mounting bracket 30, an actuator 32, a dispensing assembly 34, a suspension 36, and a gauge wheel 38.

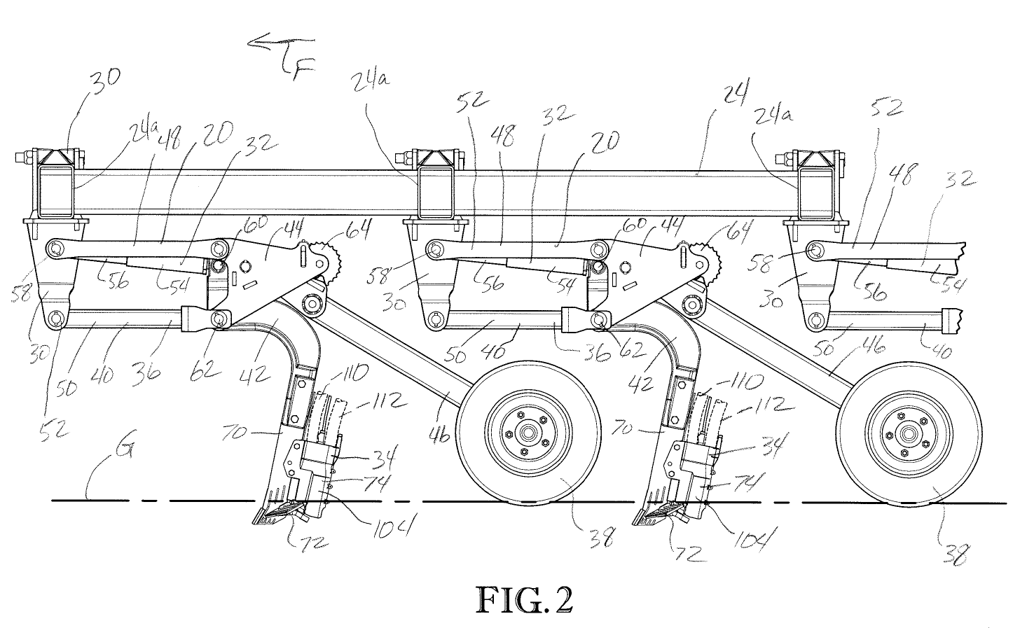

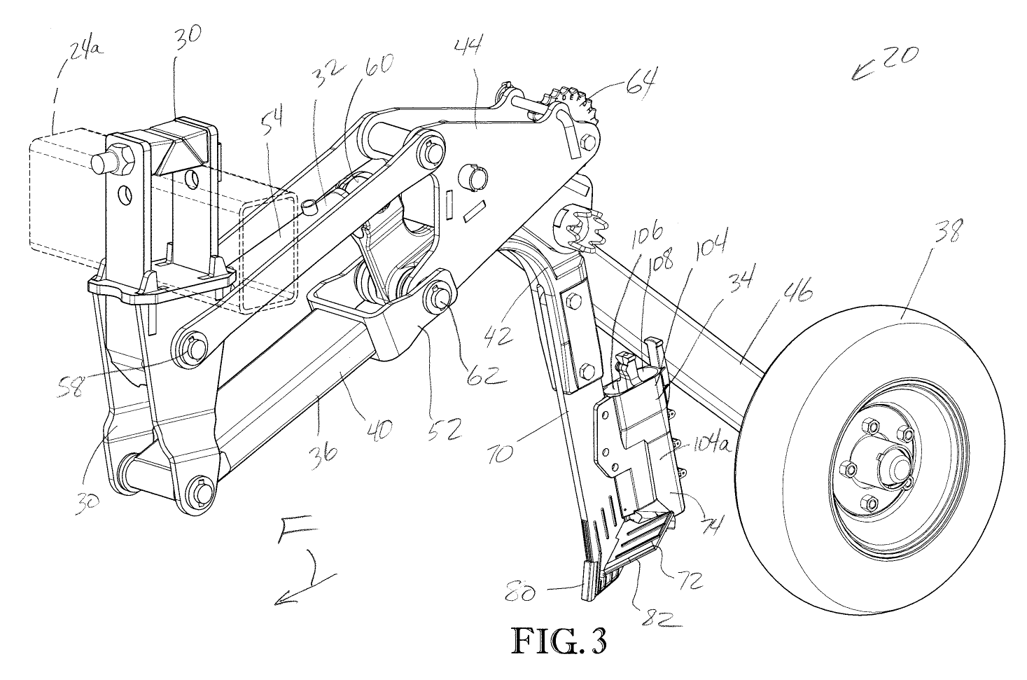

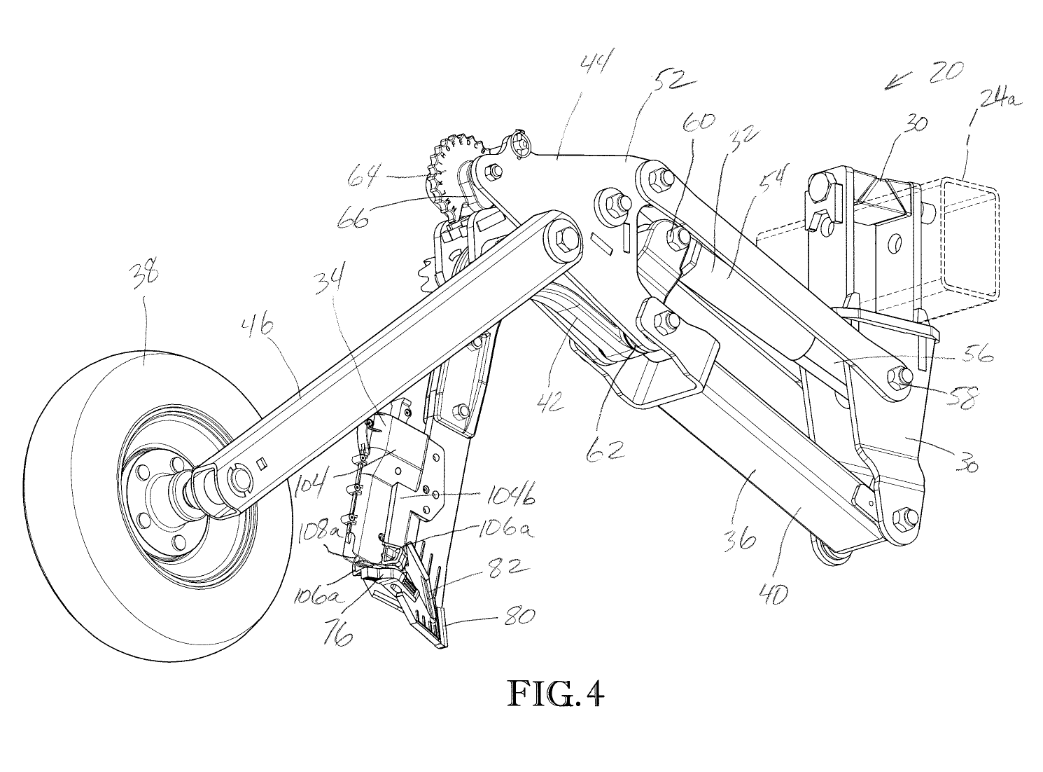

Turning to FIGS. 2-4, the suspension 36 is configured to shift with the dispensing assembly 34 vertically so that the opener 20 can be moved between a raised transport position (see FIGS. 3 and 4) and a lowered operating position (see FIG. 2). More specifically, the actuator 32 is operably connected to the suspension 36 to drive the dispensing assembly 34 and the suspension 36 between the positions.

In the depicted embodiment, the suspension 36 preferably includes a linkage 40, a shank support arm 42, a suspension arm 44, and a trailing arm 46. The mounting bracket 30 preferably supports the suspension 36 in a location generally below the toolbar 24a. In the usual manner, the mounting bracket 30 can be loosened or detached from the toolbar 24a to move the opener 20 to another location on the toolbar 24a (or to a location on another toolbar 24a). Additional details of the mounting bracket 30 are disclosed in pending provisional Application No. 62/628,558, filed Feb. 9, 2018, entitled MOUNTING BRACKET FOR AGRICULTURAL ROW UNIT, which is hereby incorporated in its entirety by reference herein.

The illustrated linkage 40 includes upper and lower links 48,50. The linkage 40, suspension arm 44, and mounting bracket 30 cooperatively form a parallel, four-bar linkage assembly 52.

While the illustrated four-bar linkage assembly 52 is preferred to support other components of the opener 20 in the transport and operating positions, the opener 20 could have an alternative support structure. For instance, the suspension 36 could have an alternative linkage to interconnect the bracket 30 and the suspension arm 44 and permit vertical shifting movement of the suspension arm 44. It will also be appreciated that the suspension arm 44 could be alternatively configured or wholly eliminated without departing from certain aspects of the present invention.

The actuator 32 preferably comprises a conventional hydraulic cylinder with a cylinder body 54 and a piston 56 (see FIG. 3). As is customary, the piston 56 is slidable inwardly relative to the body 54 to retract the actuator 32 and is slidable outwardly relative to the body 54 to extend the actuator 32. The actuator 32 is fluidly connected to the hydraulic system of the implement 22 via hydraulic lines (not shown). Thus, the actuator 32 fluidly communicates with the hydraulic system so that the actuator 32 can be selectively extended and retracted.

The actuator 32 is preferably mounted to drive the linkage assembly 52 between the transport and operating positions. The actuator 32 is mounted by pivotally attaching the body 54 to the mounting bracket 30 at an upper bracket pivot joint 58 and by pivotally attaching the piston 56 to the support arm 42 at a piston pivot joint 60 (see FIGS. 2-4). Of course, the orientation of this cylinder attachment may be reversed if desired.

The support arm 42 is pivotally mounted to the suspension arm 44 and the lower link 50 at a lower suspension arm pivot joint 62. The support arm 42 is attached to the trailing arm 46 and contacts a gauge adjustment wheel 64. The wheel 64 includes a cam 66 that engages the support arm 42 and is rotatably supported by the suspension arm 36 to adjust the depth of the opener 20 in the operating position (see FIG. 4).

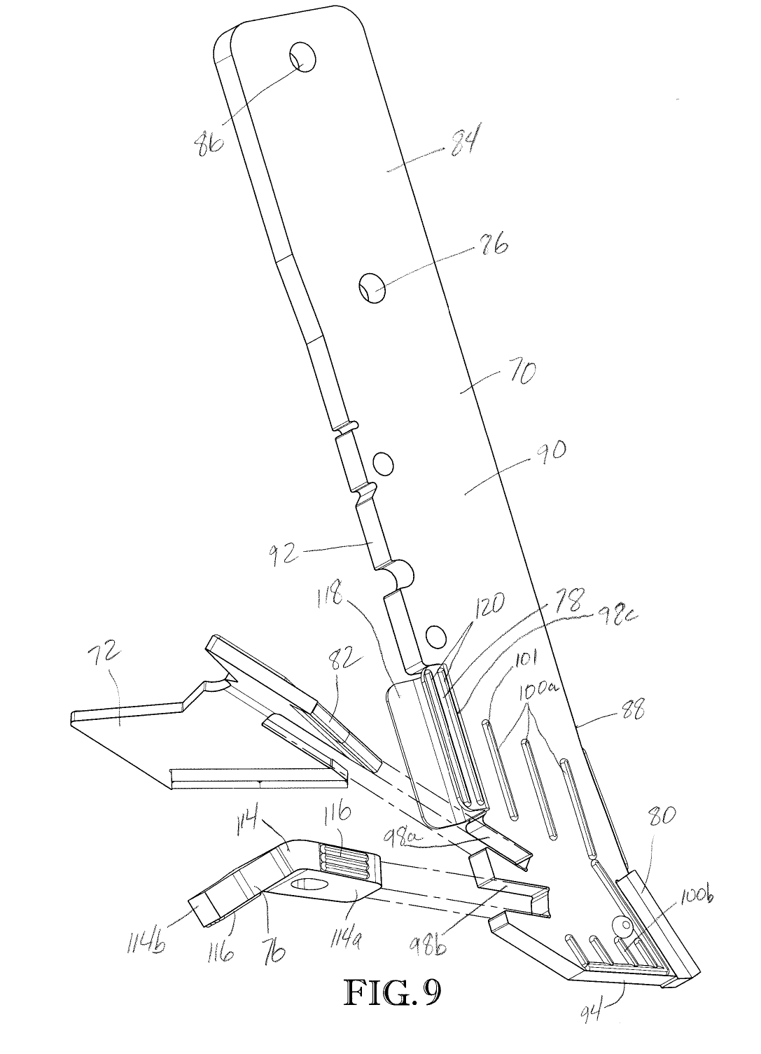

Turning to FIGS. 2-11, the dispensing assembly 34 preferably includes a shank 70, a shovel 72, a boot 74, a guide member 76, a boot guard 78, shank wear tablet 80, and shovel wear tablets 82.

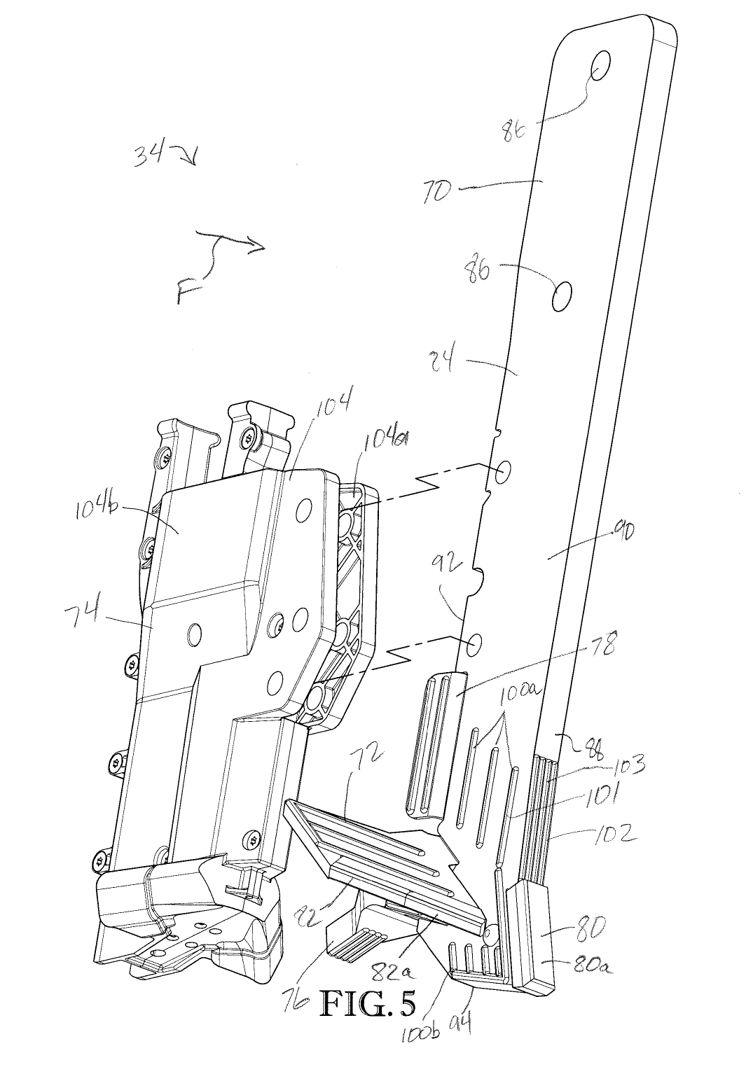

The shank 70 is configured to engage the ground G as the opener 20 is being advanced in the operating position (see FIG. 2). The shank 70 preferably includes an elongated, unitary shank plate 84 (see FIGS. 5-9). The shank plate 84 is generally vertically oriented and presents a pair of mounting holes 86 adjacent to its upper end that allow for bolting or otherwise attaching the shank 70 to the support arm 42. Again, the support arm 42 is controlled by the actuator 32.

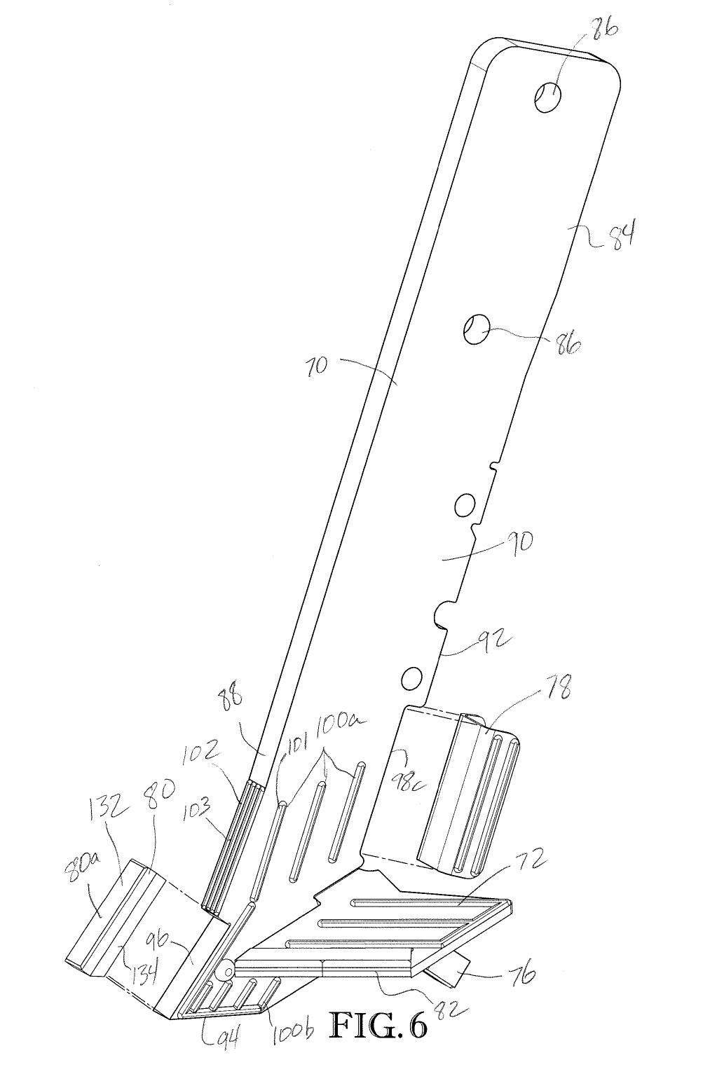

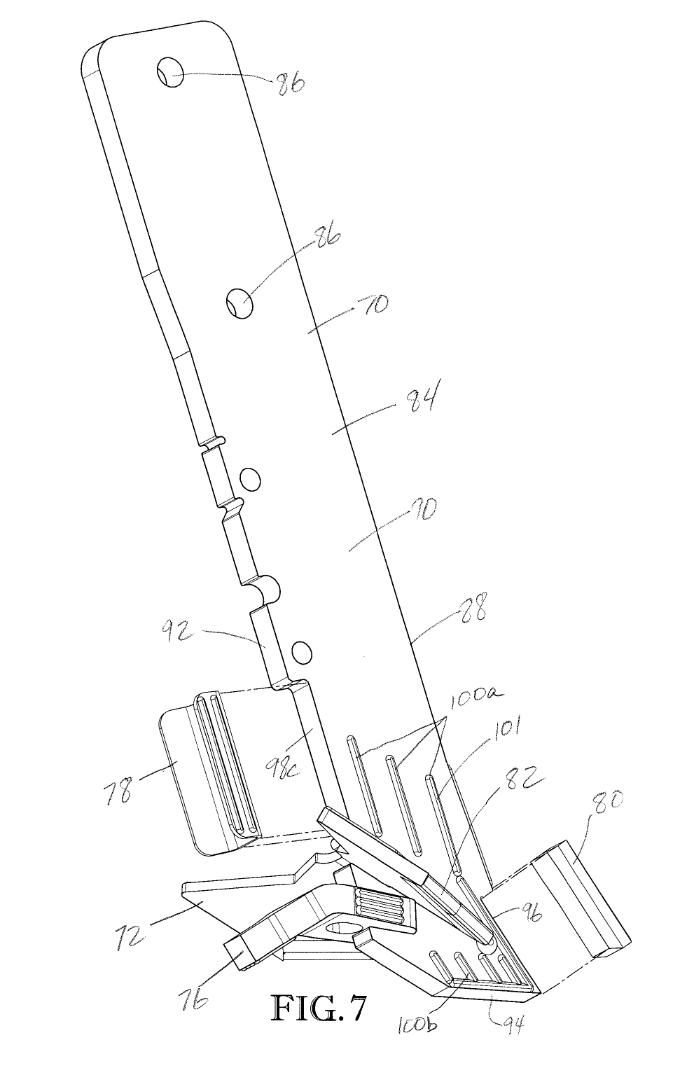

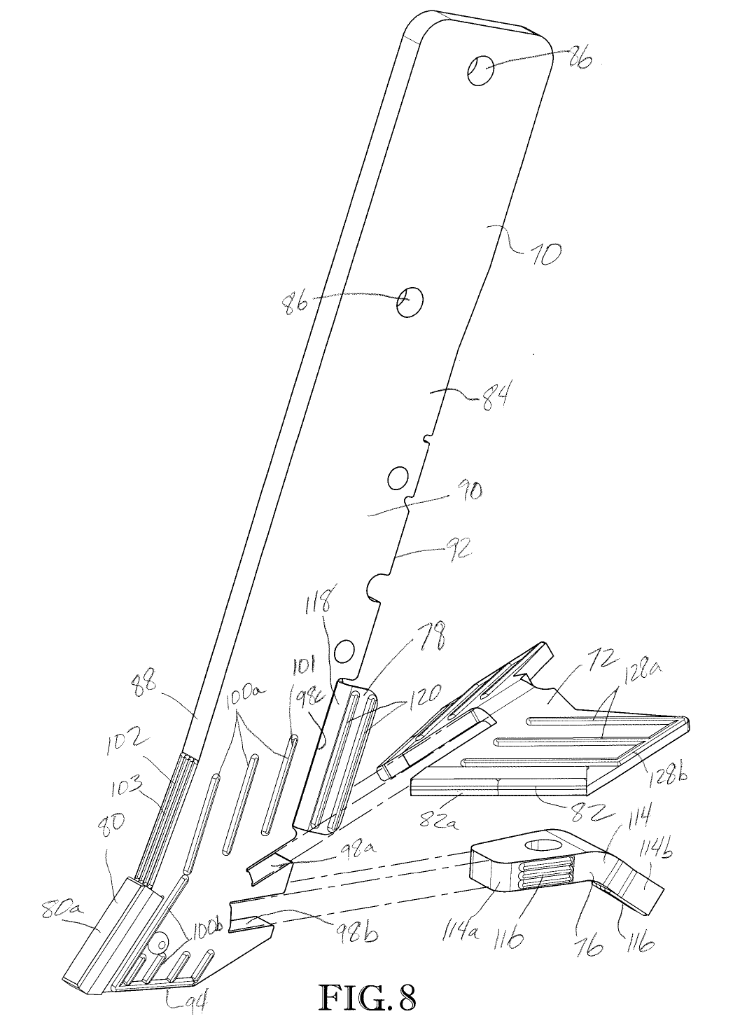

The depicted shank plate 84 also includes a forward edge 88, opposite sides 90, a trailing edge 92, and a bottom margin 94. The forward edge 88 defines a tablet notch 96 that extends to the bottom margin 94 and is configured to receive a shank wear tablet, as will be discussed (see FIGS. 6, 7, and 10). The shank plate 84 also presents a shovel notch 98a and a guide notch 98b positioned in the trailing edge 92 (see FIGS. 8-10). The shank plate 84 further presents a plate notch 98c positioned in the trailing edge 92 (see FIGS. 6 and 7). The shovel notch 98a receives the seed shovel 26, while the guide notch 98b receives the guide member 76 (see FIGS. 8-10). The plate notch 98c receives the boot guard 78 (see FIGS. 6 and 7).

The shank 24 preferably includes a unitary shank plate structure, but may alternatively be formed of multiple elements secured to one another. In alternative embodiments, multiple pieces of material may be temporarily or permanently connected together to form the shank plate structure.

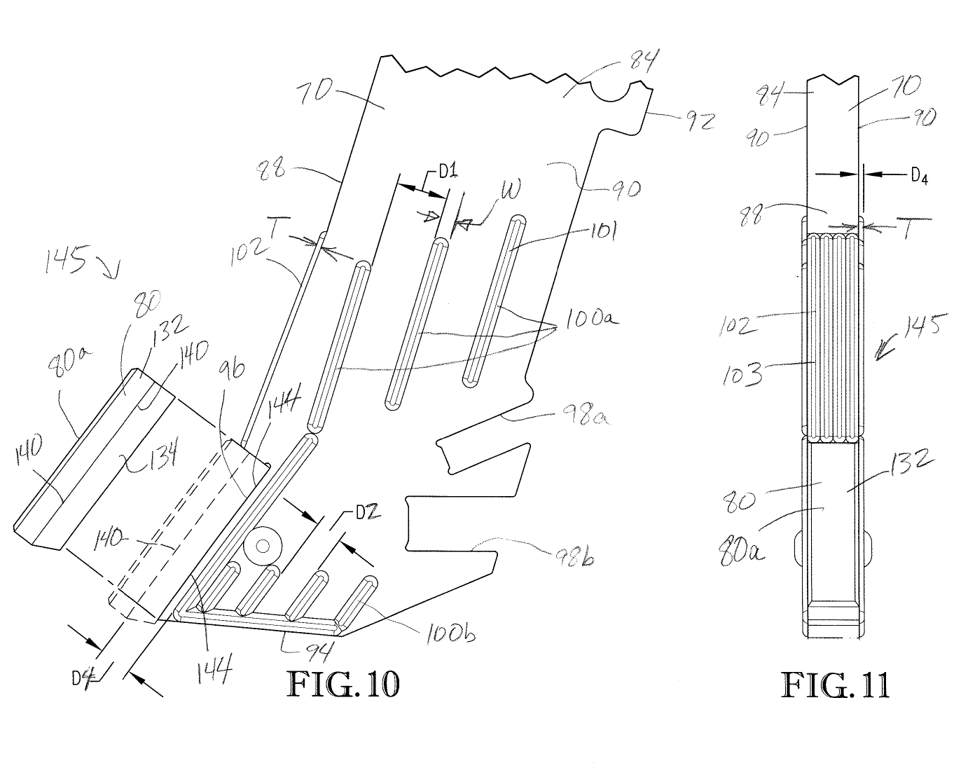

The shank 70 preferably includes multiple wear beads 100a,b applied to the sides 90 of the shank plate 84 and multiple wear beads 102 applied to the forward edge 88 of the shank plate 84 (see FIGS. 5, 10, and 11). The wear beads 100,102 each define a width dimension W and a thickness dimension T (see FIGS. 10 and 11). The thickness dimension T is preferably about five hundredths of an inch (0.05″), although the thickness could be larger or smaller according to certain aspects of the present invention. For each wear bead, the thickness dimension T is also preferably less than the width dimension W, although certain principles of the present invention encompass alternative width and thickness configurations and relationships. For instance, depending on the parameters of the laser metal deposition process, the wear beads could have an alternative bead profile.

The illustrated wear beads 100a,b are spaced apart from one another to cooperatively define a distributed wear surface 101. Adjacent pairs of wear beads 100a preferably define a spacing distance dimension D1 greater than a width dimension W of the wear beads 100a (see FIG. 10). Similarly, adjacent pairs of wear beads 100b preferably define a spacing distance dimension D2 greater than a width dimension W of the wear beads 100b (see FIG. 10). In the illustrated embodiment, the spacing dimensions D1 and D2 preferably range from about two-tenths of an inch (0.2″) to about one half inch (0.5″). More preferably, the ratio of each spacing dimension D1 and D2 to the width dimension W of the wear beads ranges from about 4:1 to about 10:1.

It is also within the scope of certain aspects of the present invention where one or more pairs of wear beads are alternatively spaced apart. Furthermore, one or more pairs of wear beads could be applied in contact with each other so that little or no spacing is provided therebetween.

Again, the illustrated wear beads 102 are applied to the forward edge 88 of the shank plate 84 (see FIGS. 5, 10, and 11). The wear beads 102 preferably extend vertically from the tablet notch 96 to cooperatively present a wear surface 103. The illustrated wear beads 102 are positioned alongside one another so that pairs of adjacent wear beads 102 contact each other and are generally parallel (see FIG. 11). It is also within the scope of the present invention where one or more pairs of wear beads are spaced apart.

The wear beads 100,102 preferably comprise a tungsten carbide wear material applied using a laser metal deposition process. It is also within the scope of certain aspects of the present invention for one or more other wear materials to be additionally or alternatively applied to the shank plate. Yet further, for some aspects of the present invention, it will be appreciated that the wear beads could be applied using an alternative process.

In use, the opener 20 may be moved in a direction of travel over a field such that the shank 70 cuts through the soil to create a fertilizer trench (not shown) which may generally correspond in size and shape to the lower portion of the shank 70.

Turning to FIGS. 2-5, the illustrated boot 74 preferably includes a body 104 with molded left and right body halves 104a,b. An interior of the assembled body 104 may be subdivided into several passages, wherein each body half 104a,b provides one half of each passage such that when the body halves 104a,b are secured together the passages are substantially fully defined. These passages include, among other things, a seed passage 106 and a granular fertilizer passage 108 (see FIG. 3). The seed passage 106 is configured to be supplied with seeds by a seed supply conduit 110 (see FIG. 2). The granular fertilizer passage 108 is configured to be supplied with granular fertilizer by a fertilizer supply conduit 112 (see FIG. 2).

The conduits 110,112 are preferably in communication with respective metered reservoirs (not shown) of seeds and fertilizer. In one implementation, the granular fertilizer passage 108 extends through the center plane of the boot body 104 defined by the two boot halves 104a,b and discharges through a central fertilizer outlet 108a (see FIG. 4). The seed passage 106 discharges through seed outlets 106a on opposite sides of the fertilizer passage 108 (see FIG. 4). In this manner, all of the fertilizer products are maintained in a central fertilizer trench (not shown) to avoid fertilizer toxicity of the seeds.

The boot 28 of the depicted embodiment facilitates consistent placement of all seeds and fertilizer products, and allows for switching between any combination of seed and fertilizer products without changing the boot 28. It should be noted that the present invention is not limited to dispensing the seeds and treatment substantially simultaneously. Additional preferred features of the boot 74 are disclosed in U.S. Pat. No. 9,717,173, issued Aug. 1, 2017, entitled MOLDED BOOT FOR DISPENSING SEEDS AND MULTIPLE TREATMENTS, which is hereby incorporated in its entirety by reference herein.

While the use of the illustrated boot 74 is preferred, it is entirely within the scope of the present invention where the opener includes an alternative boot device to facilitate seed and/or fertilizer placement. However, it will also be appreciated that at least some aspects of the present invention could be incorporated into an opener or other tillage tool that does not include a boot.

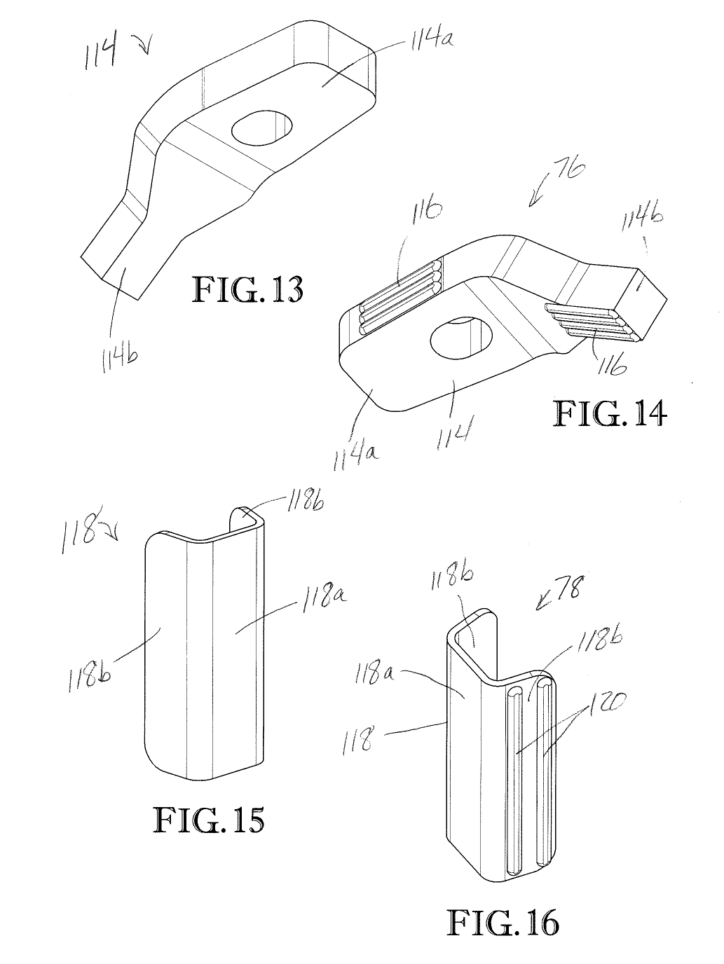

Turning to FIGS. 8, 9, and 13-16, the guide member 76 preferably includes a guide plate 114 and wear beads 116 applied to the guide plate 114. The guide plate 114 presents forward and aft sections 114a,b (see FIG. 13). The aft section 114b preferably extends at an oblique angle to the forward section 114a.

The depicted guide member 74 is formed by applying the wear beads 116 to the forward and aft sections 114a,b using laser metal deposition. The guide member 76 is preferably secured by inserting the forward section 114a into the notch 98b and welding the guide plate 114 to the shank 70.

The boot guard 78 preferably includes a curved plate 118 and wear beads 120 applied to the cover plate 118. The curved plate 118 includes a center section 118a and opposite side sections 118b (see FIG. 15).

The depicted boot guard 78 is formed by applying the wear beads 120 to the side sections 118b using laser metal deposition. The boot guard 78 is preferably secured by inserting the center section 118a into the notch 98c and welding the curved plate 118 to the shank 70.

Again, the wear beads 116,120 preferably comprise a tungsten carbide wear material applied using a laser metal deposition process. It is also within the scope of certain aspects of the present invention for one or more other wear materials to be additionally or alternatively applied. Yet further, for some aspects of the present invention, it will be appreciated that the wear beads could be applied using an alternative process.

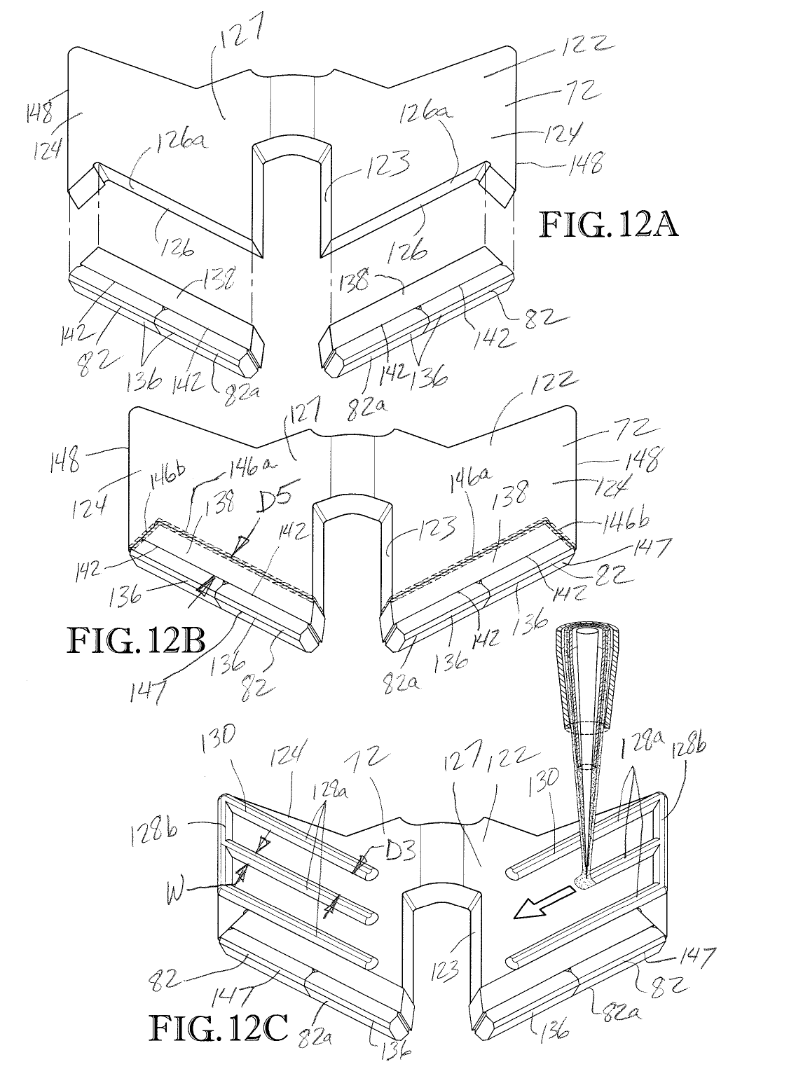

Turning to FIGS. 5-9 and 12A-12C, the shovel 72 is also configured to engage the ground G. In particular, the shovel 72 is operable to engage the ground G when the opener 20 is being advanced forward while in the operating position (see FIG. 2). The shovel 72 includes a shovel plate 122 that is formed to define a mounting notch 123 and a pair of opposite wings 124 (see FIGS. 12A-12C).

The illustrated mounting notch 123 interlocks with the shovel notch 98a of the shank 70 when the shovel 72 is secured to the shank 70. The shovel 72 is positioned on the shank 70 so that the wings 124 project downwardly and outwardly from the lower portion of the shank 70 in generally opposite left and right directions.

The wings 124 are preferably mirror images of one another and present respective forward edges 126 and an upper surface 127 (see FIGS. 12A-12C). The forward edges 126 define respective notches 126a to receive shovel wear tablets 82. As will be explained, the wear tablets 82 provide leading edges of the shovel 72 that serve as wear surfaces. In alternative implementations, the forward edges 126 themselves (either partly or entirely) may be hardened to resist wear.

The shovel 72 also preferably includes multiple wear beads 128a,b applied to the upper surface 127 of the wings 124 (see FIG. 12C). The wear beads 128a preferably extend generally parallel to the corresponding notches 126a. The illustrated wear beads 128a,b cooperatively define a distributed wear surface 130 (see FIG. 12C). Adjacent pairs of wear beads 128a preferably define a spacing distance dimension D3 greater than a width dimension W of the wear beads 128 (see FIG. 12C). It is also within the scope of certain aspects of the present invention for one or more pairs of wear beads to be alternatively spaced apart. For example, one or more pairs of wear beads could be applied in contact with each other so that no spacing is provided therebetween.

The wear beads 128 preferably comprise a tungsten carbide wear material applied to the shovel plate 122 using a laser metal deposition process (see FIG. 12C). It is also within the scope of certain aspects of the present invention for one or more other wear materials to be additionally or alternatively applied to the shovel plate. Yet further, for some aspects of the present invention, it will be appreciated that the wear beads could be applied using an alternative process.

In use, the wings 124, in combination with the shovel wear tablets 82, may create generally horizontally oriented left and right shelves (not shown) in the soil as the opener 20 is advanced in the forward direction F. In particular, the wings 124 create left and right shelves that are located above and to each side of the fertilizer trench to receive seeds.

Although the illustrated shovel configuration is preferred, certain principles of the present invention are applicable to a shovel that is alternatively shaped and/or positioned on the shank. For instance, a sideband shovel having a single wing could be used in place of the depicted shovel. With respect to some aspects of the present invention, the opener could also be devoid of a shovel.

Turning to FIGS. 10-12C, the wear tablets 80,82 are configured to provide respective tablet wear surfaces 80a,82a to engage the ground G. Again, the depicted wear tablets preferably include the shank wear tablet 80 and shovel wear tablets 82. As will be described, the tablets 80,82 are preferably pre-brazed prior to attachment to the corresponding base tool structure.

Although the wear tablets 80,82 are preferred, it is entirely within the ambit of certain aspects of the present invention for one or more wear tablets to be additionally or alternatively applied to one or more other locations of the opener. As will be explained below, the opener could be variously configured to utilize wear tablets suitable for reinforcing the shank or other features of the opener.

The shank wear tablet 80 preferably includes a wear plate 132 and a backing plate 134 (see FIGS. 6 and 10). The backing plate 134 is configured to provide a substrate for attachment to and support of the wear plate 132. At the same time, the backing plate 134 is configured to be laser welded directly to the base tool structure provided by the shank plate 84 of the shank 70.

The shovel wear tablets 82 each preferably include wear plates 136 and a backing plate 138 (see FIGS. 12A-12C). Again, the backing plate 138 is configured to provide a substrate for attachment to and support of the wear plate 136. At the same time, the backing plate 138 is configured to be laser welded directly to the base tool structure provided by the shovel plate 122 of the shovel 72 (see FIGS. 12A-12C).

Most preferably, the backing plates 134,138 are configured to be laser welded to the respective base tool structure so as to fix the corresponding pre-brazed wear tablet to the base tool structure.

As used herein, the base tool structure generally refers to the shank 70 and/or the shovel 72. However, it is within the ambit of the present invention for the base tool structure to refer additionally or alternatively to another tool structure.

The backing plates 134,138 each preferably include a backing plate material that is substantially the same as the base tool material of the corresponding shank or shovel. In this manner, the backing plate material and base tool material facilitate laser welding of the backing plate to the base tool structure. Most preferably, the backing plate material for each backing plate 134,138 includes a low-alloy carbon steel material. Furthermore, the backing plate material and the base tool material preferably comprise substantially the same low-alloy carbon steel material. However, in various alternative embodiments, the backing plate material may alternatively or additionally include one or more other metallic materials.

The wear plates 132,136 present corresponding wear surfaces 80a,82a configured to engage the ground. The wear plates 132,136 each preferably include a wear material with a hardness greater than the backing plate material. The wear material also preferably has a hardness greater than the base tool material of the shank and/or shovel. Most preferably, the wear material comprises a tungsten carbide material. However, according to certain aspects of the present invention, the wear plates may additionally or alternatively include one or more other wear materials.

Each wear tablet 80,82 is preferably formed prior to being fixed to the corresponding base tool structure (i.e., the shank or the shovel). More preferably, each shank wear tablet 80 has a wear plate 132 and backing plate 134 that are pre-brazed along a brazing joint 140 (see FIG. 10). Similarly, each shovel wear tablet 82 has wear plates 136 and a backing plate 138 that are pre-brazed along a brazing joint 142. In this manner, the corresponding wear plates and backing plates are fixed to each other via a brazing process prior to the tablet being fixed to the base tool structure. Although such pre-brazing is preferred, certain aspects of the present invention encompass an alternatively opener where less than all of the wear tablets (but at least one) have the wear plate(s) fixed to the backing plate at the same time or after the backing plate is fixed to the base tool structure.

The shank wear tablet 80 is preferably laser welded to the base tool structure of the shank plate 84 so that the wear plate 132 is located ahead of the backing plate 134 relative to the forward direction F (see FIGS. 5 and 10). In like manner, the shovel wear tablet 82 is preferably laser welded to the base tool structure of the shovel plate 122 so that the wear plates 136 are located ahead of the backing plate 138 relative to the forward direction F (see FIGS. 5, 12A, and 12B). Thus, the tablet wear surfaces 80a,82a are exposed in the forward direction F to engage the ground G.

Again, the backing plates 134,138 preferably include a backing plate material that is substantially the same as the base tool material of the corresponding shank 70 or shovel 72. Thus, the backing plate material and base tool material facilitate laser welding of each backing plate to the corresponding base tool structure.

The shank wear tablet 80 is preferably positioned in the notch 96 and laser welded to the shank plate 84. In particular, the backing plate 134 of the wear tablet 80 is welded to the shank plate 84 along a generally linear laser weld joint 144 (see FIG. 10). The laser weld joint 144 is spaced from the brazing joint 140 to define a spacing dimension D4 (see FIG. 10). Preferably, the laser weld joint 144 is spaced from the brazing joint 140 so that the spacing dimension D4 is within about one quarter of an inch (¼″). However, the spacing dimension D4 could be greater than a quarter of an inch without departing from the scope of certain aspects of the present invention.

The shank wear tablet 80 is preferably fixed to the shank plate 84 so that the wear tablet 80 extends to the bottom margin 94 of the shank 70. Also, the wear tablet 80 is fixed to the shank 70 so that the wear surface 80a of the wear tablet 80 provides at least part of a leading edge 145 of the shank 70.

Again, the wear tablet 80 is preferably fixed to the shank 70 after the wear plate 132 is fixed to the backing plate 134. As discussed above, the wear plate 132 and backing plate 134 are preferably pre-brazed to each other prior to the wear tablet 80 being laser welded to the shank plate 84.

The wear beads 100a,b and 102 are preferably applied to the shank 70 adjacent the wear tablet 80. The wear beads 102 extend upwardly from the wear tablet 80 so that the wear beads 102 and wear tablet 80 cooperatively reinforce the shank 70 and cooperatively provide wear-resistant leading edge 145 of the shank 70.

In a similar way, the wear beads 100a,b are located behind the wear tablet 80 and extend generally parallel to the wear tablet 80. The wear beads 100a,b and wear tablet 80 cooperatively reinforce the sides of the shank 70 and cooperatively provide wear-resistant sides.

The wear beads 100a,b and 102 are preferably applied to the shank 70 using laser metal deposition. It will be appreciated that this process of applying the wear beads preferably occurs after the wear tablet 80 is laser welded to the shank 70, although the wear beads could be applied before or during laser welding of the tablet 80 to the shank 70.

The shovel wear tablets 82 are preferably positioned in the respective notches 126a and laser welded to the shovel 72. In particular, the backing plate 138 of each wear tablet 82 is welded to the shovel plate 122 along generally laser weld joints 146a,b (see FIG. 12B). The weld joints 146a are spaced from the respective brazing joints 142 to define a spacing dimension D5 (see FIG. 12B). Preferably, the weld joints 146a are spaced from the brazing joint 142 so that the spacing dimension is within about one quarter of an inch (¼″). However, the spacing dimension D5 could be greater than a quarter of an inch without departing from the scope of certain aspects of the present invention.

The wear tablets 82 are preferably fixed to the shovel 72 so that the wear tablet 82 extends from the notch 123 to outboard margins 148 of the shovel 72 (see FIG. 12B). Also, the wear tablets 82 are fixed to the shovel 72 so that the wear surfaces 82a provide at least part of a pair of leading edges 147 of the shovel 72 (see FIGS. 12B and 12C). It will also be appreciated that the leading edges of the shovel could be at least partly formed by other wear-resistant elements, such as one or more wear beads applied by laser metal deposition.

Again, the wear tablets 82 are preferably fixed to the shovel 72 after the wear plates 136 are fixed to the respective backing plate 138. As discussed above, the wear plates 136 and backing plate 138 are preferably pre-brazed to each other prior to the wear tablet 82 being laser welded to the shovel plate 122.

The wear beads 128a,b are preferably applied to the shovel plate 122 adjacent the wear tablets 82. The wear beads 128a,b are located behind respective wear tablets 82. The depicted wear beads 128a extend generally parallel to the respective wear tablets 82. The wear beads 128a,b and wear tablet 82 cooperatively reinforce the shovel 72 and cooperatively provide wear-resistant shovel upper surfaces.

The wear beads 128a,b are preferably applied to the shovel plate 122 using laser metal deposition. It will be appreciated that this process of applying the wear beads preferably occurs after the wear tablets 82 are laser welded to the shovel 72, although the wear beads could be applied before or during laser welding of the tablet 82 to the shovel 72.

Again, it is within the ambit of certain aspects of the present invention for the opener to be alternatively configured to utilize wear tablets to provide alternative reinforcement of the shank or other features of the opener. Although the wear tablets 80,82 are preferred, it is entirely within the scope of the present invention for one or more wear tablets to be additionally or alternatively applied to one or more other locations of the opener. For instance, one or more additional wear tablets could be fixed to the leading edge 88 of the shank plate 84.

Similarly, one or more wear tablets could be fixed to the sides of the shank plate 84. It will be appreciated that such wear plates could be used in addition to or alternatively to the depicted wear beads 100a,b. Yet further, one or more wear tablets could be fixed relative to other features of the opener, such as the guide member or the boot guard.

To the extent that some opener features may have a nonmetallic construction, such as the boot, it will be appreciated that one or more wear tablets could be fixed to an adjacent base structure to provide suitable wear resistance. Yet further, for some aspects of the present invention, one or more wear tablets could be attached to such a nonmetallic component through means other than laser welding (e.g., by using one or more fasteners to removably attach the wear tablet to the nonmetallic substrate).

Although the above description presents features of preferred embodiments of the present invention, other preferred embodiments may also be created in keeping with the principles of the invention. Such other preferred embodiments may, for instance, be provided with features drawn from one or more of the embodiments described above. Yet further, such other preferred embodiments may include features from multiple embodiments described above, particularly where such features are compatible for use together despite having been presented independently as part of separate embodiments in the above description.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. An agricultural tillage tool configured to be advanced along a field in a forward direction, said tool comprising:
a base tool structure configured to engage the ground while being advanced, and
a pre-brazed wear tablet,
said wear tablet including a metallic wear plate and a steel backing plate, with the plates being brazed to one another,
said metallic wear plate including a wear material and said backing plate including a backing plate material, with the wear material having a hardness greater than the backing plate material,
said backing plate being laser welded to the base tool structure so as to fix the pre-brazed wear tablet to the base tool structure, with the metallic wear element being located ahead of the backing plate relative to the forward direction.

2. The agricultural tillage tool as claimed in claim 1,
said wear material comprising a tungsten carbide material.

3. The agricultural tillage tool as claimed in claim 1,
said base tool structure including a base tool material,
said wear material having a hardness greater than the base tool material.

4. The agricultural tillage tool as claimed in claim 3,
said wear material comprising a tungsten carbide material.

5. The agricultural tillage tool as claimed in claim 4,
said base tool material comprising a low-alloy carbon steel material.

6. The agricultural tillage tool as claimed in claim 1,
said base tool structure including a base tool material,
said backing plate material and said base tool material each comprising a low-alloy carbon steel material to facilitate laser welding of the backing plate to the base tool structure.

7. The agricultural tillage tool as claimed in claim 6,
said backing plate material and said base tool material comprising substantially the same low-alloy carbon steel material.

8. The agricultural tillage tool as claimed in claim 6,
said wear material having a hardness greater than the base tool material.

9. The agricultural tillage tool as claimed in claim 8,
said wear material comprising a tungsten carbide material.

10. The agricultural tillage tool as claimed in claim 1,
said tillage tool comprising an opener to dispense seed and/or fertilizer.

11. The agricultural tillage tool as claimed in claim 10,
said tillage tool including a boot supported by the base tool structure and configured to dispense seed and/or fertilizer.

12. The agricultural tillage tool as claimed in claim 1, further comprising:
a plurality of beads of another wear material applied to the base tool structure adjacent the wear tablet, with the beads being applied via laser metal deposition.

13. The agricultural tillage tool as claimed in claim 12,
said beads presenting a bead thickness dimension,
said beads cooperatively providing at least one pair of adjacent beads that define a bead spacing dimension therebetween, with the bead spacing dimension being greater than the bead thickness dimension.

14. A method of reinforcing an agricultural tillage tool, wherein the tool includes a base tool structure configured to engage the ground while being advanced in a forward direction, said method comprising the steps of:
(a) fixing a metallic wear plate to a steel backing plate to provide a metallic wear tablet, with the metallic wear tablet presenting a tablet wear surface; and
(b) after step (a), laser welding the backing plate to the base tool structure so that the tablet wear surface is exposed in the forward direction.

15. The method as claimed in claim 14
step (a) including the step of brazing the wear tablet to the steel backing plate.

16. The method as claimed in claim 14,
step (b) including the step of laser welding within about one quarter of an inch of the joint between the metallic wear plate and the steel backing plate.

17. The method as claimed in claim 14, further comprising the step of:
(c) applying another wear surface to the base tool structure adjacent the tablet wear surface.

18. The method as claimed in claim 17,
step (c) including the step of applying one or more beads of a wear material to the base tool structure via laser metal deposition to provide the another wear surface.

19. The method as claimed in claim 18,
performing step (c) after step (b).

20. The method as claimed in claim 14, further comprising the step of:
(c) applying a plurality of beads of a wear material to the base tool structure via laser metal deposition,
step (c) including the step of spacing the beads apart from each other a distance greater than the width of the beads.

21. The method as claimed in claim 14,
said metallic wear tablet including a tungsten carbide material.
